(19) United States
(12) Patent Application Publication
(10) Pub. No.: US 2011/0019581 A1
(43) Pub. Date: Jan. 27, 2011

(54) METHOD FOR IDENTIFYING PACKETS AND APPARATUS USING THE SAME

(75) Inventor: YI LON CHIN, HSINCHU COUNTY (TW)

Correspondence Address: HAMRE, SCHUMANN, MUELLER & LARSON, P.C., P.O. BOX 2902, MINNEAPOLIS, MN, 55402-0902, US

(73) Assignee: RALINK TECHNOLOGY CORPORATION, HSINCHU COUNTY (TW)

(21) Appl. No.: 12/841,522

(22) Filed: Jul. 22, 2010

(30) Foreign Application Priority Data
Jul. 23, 2009 (TW) 098124820

(51) Int. Cl. H04L 12/24

(52) U.S. Cl. 370/253

(57) ABSTRACT

A method for identifying packets comprises the steps of: obtaining a cumulative distribution function (CDF) and a probability distribution function (PDF) in accordance with a plurality of packets stored in an entry of a data flow table; obtaining a time interval under the condition of the CDF being a specified value; obtaining a ratio of the quantity of the plurality of packets included within a specified range around the time interval; determining whether attributes of the plurality of packets are substantially the same in accordance with the PDF; and identifying the plurality of packets in accordance with the ratio and whether the attributes of the plurality of packets are substantially the same.

### BACKGROUND OF THE INVENTION

1. Field of the Invention

The present invention relates to packet processing, and more particularly, to a method for identifying packets and an apparatus using the same.

2. Description of the Related Art

As the internet becomes increasingly popular, all kinds of applications have been developed, and many research groups are dedicated to the research of improving the internet's performance regarding data transmission. The packet lengths of the transmitted data are different for different applications, wherein these applications may include various kinds of packet processing techniques, such as checking, decomposing, combining, searching, content comparing and forwarding techniques, etc. With the continuing increase in the required bandwidth and packet throughput of household internet, campus internet and enterprise internet, the performance of packet transmission and the development of packet processing techniques are drawing more and more attention.

Packet delay causes degradation of data performance including video quality. Therefore, in addition to improving internet transmission quality, the timing for transmitting all kinds of packets should also be managed properly. For example, the priority of each packet could be marked according to the urgency level thereof so that the internet apparatus can process these packets based on their service priority. With the improvement of internet transmission speeds and the requirement of processing the packets of voice transmission and multimedia transmission simultaneously, various techniques and methods have been provided to improve the performance of packet processing. System IC design houses are dedicated to improving CPU clock rates, increasing cache memory space or utilizing a dedicated processor for packet processing. Extensive research seeks to improve packet transmission efficiency, including that of Masaki Tai, et al. from Osaka City University, who developed a technique to analyze the transmission characteristics of bulk packets and real-time packets and determine whether packets are real-time video packets in accordance with a cumulative distribution function (CDF) of arrival time intervals of the packets.

### SUMMARY OF THE INVENTION

The method and apparatus for identifying packets in accordance with the present invention determine whether packets stored in each entry of a data flow table are real-time video packets in accordance with the CDF of the arrival time intervals of the packets and the probability distribution function PDF of the lengths of the packets.

One embodiment of the present invention discloses a method for identifying packets, comprising the steps of: obtaining a cumulative distribution function (CDF) and a probability distribution function (PDF) in accordance with a plurality of packets stored in an entry of a data flow table; obtaining a time interval under the condition of the CDF being a specified value; obtaining a ratio of the quantity of the plurality of packets included within a specified range around the time interval; determining whether attributes of the plurality of packets are substantially the same in accordance with the PDF; and identifying the plurality of packets in accordance with the ratio and whether the attributes of the plurality of packets are substantially the same.

Another embodiment of the invention discloses a wireless apparatus. The wireless apparatus comprises a receiving unit, a checking unit, a storing unit, a recording unit, a calculating unit and a determining unit. The receiving unit is utilized for receiving at least one packet. The checking unit is utilized to check tuples of the packet and determine whether the packet is an identified datum and a monitored datum in accordance with a data flow table. If the packet is not the monitored datum, a new entry is created in the data flow table and the packet is stored in the new entry. The storing unit is utilized to store the packet in the entry to which the packet belongs in accordance with the tuples of the packet. The recording unit is utilized to record the arrival time and the length of the packet. In accordance with the packets stored in an entry of the data flow table, the calculation unit is utilized to obtain a CDF, a PDF, a time interval under the condition of the CDF being a specified value and a ratio of the quantity of the packets included within a specified range around the time interval. The determining unit is utilized to determine whether the attributes of the packets are substantially the same in accordance with the PDF and to identify the packets in accordance with the ratio and whether the attributes of the packets are substantially the same.

### BRIEF DESCRIPTION OF THE DRAWINGS

The invention will be described according to the appended drawings in which:

FIG. 1 shows a flowchart of a method for identifying packets in accordance with an exemplary embodiment of the present invention;

FIG. 2 shows a flowchart of a packet identification procedure in accordance with an exemplary embodiment of the present invention; and

FIG. 3 is a block diagram of the apparatus for identifying packets in accordance with another exemplary embodiment of the present invention.

### PREFERRED EMBODIMENT OF THE PRESENT INVENTION

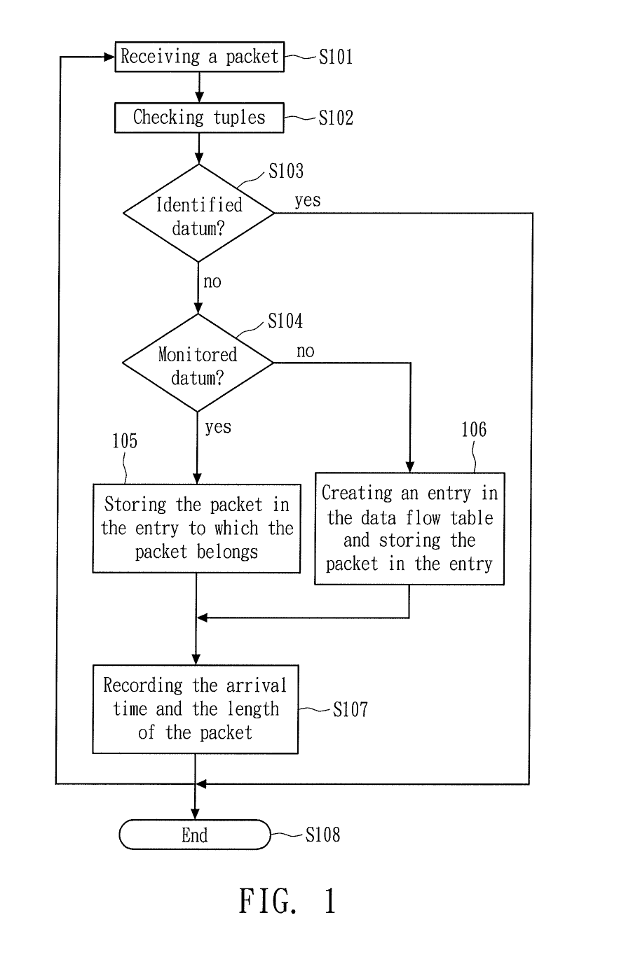

FIG. 1 shows a flowchart of a method for identifying packets in accordance with an exemplary embodiment of the present invention. In step S101, a packet is received. In step S102, tuples of the packet are checked, wherein the tuples comprise a source IP, a destination IP, a source port, a destination port and a protocol. In step S103, in accordance with a data flow table, the packet is checked to determine whether the packet is an identified datum. In accordance with the exemplary embodiment of the present invention, the identified datum is a real-time video datum. The example is an exemplary embodiment for identifying real-time video data. If YES, it means the tuples are same as the tuples of a precedent identified datum. If NO, the packet is an unidentified datum. In step S104, the packet is checked to determine whether the packet is a monitored datum. If NO, it means the packet has never been received. Therefore, in step S106, a new entry is created in the data flow table and the packet is stored in the new entry. If YES, it means a precedent packet with same tuples as the packet has previously been received. The packet is stored in an entry (for example, entry 1) of the data flow table. In step S105, the packet is stored in the entry (in this example, entry 1), to which it belongs. In step S107, the arrival time and the length of the packet are recorded.

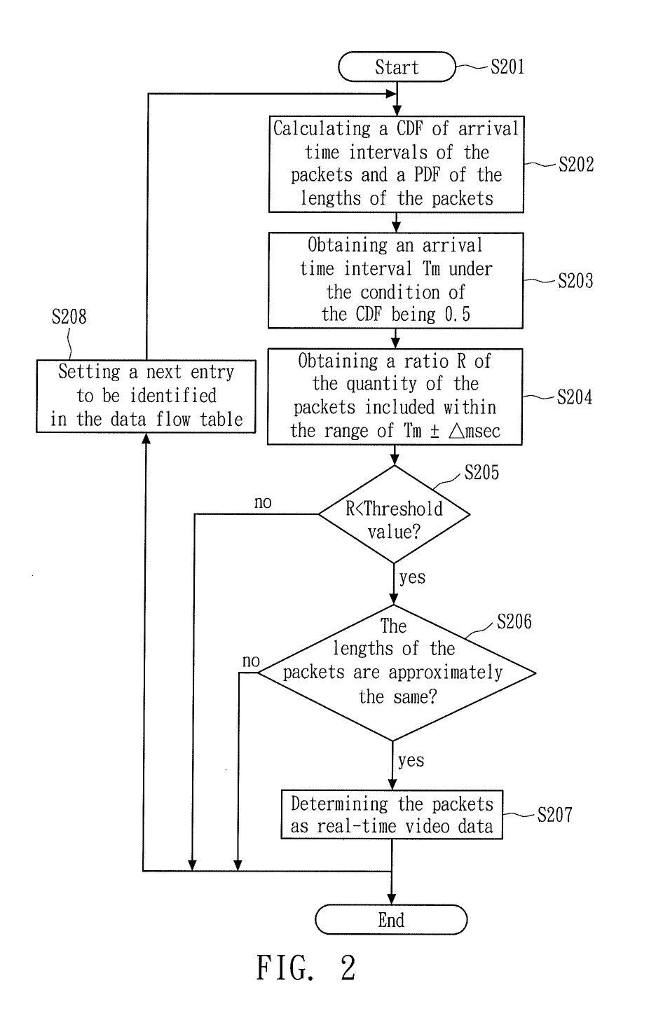

A packet identification procedure is performed to determine whether packets stored in each entry of the data flow table are real-time video data. FIG. 2 shows a flowchart of a packet identification procedure in accordance with an exemplary embodiment of the present invention. In step S201, the procedure is activated. In step S202, a cumulative distribution function (CDF) is obtained in accordance with the packets stored in an entry of the data flow table. The CDF is a CDF of arrival time intervals of the packets. In step S202, a probability distribution function (PDF) is also obtained in accordance with the packet stored in the entry of the data flow table. The PDF is a PDF of attributes of the packets, wherein the attributes are length attributes. In step S203, a time interval Tₘ, is obtained under the condition of the CDF being a specified value. For example, the specified value is about 0.5. In step S204, a ratio R of the quantity of the packets included within the range of Tₘ±Δmsec is obtained, wherein the value of symbol Δ is a range specified by a user. In step S205, whether the ratio R is less than a threshold value is checked. If the answer is no, it means the packets do not belong to real-time video data. In step S206, whether the lengths of the packets are substantially the same is checked in accordance with the PDF. For example, whether the lengths of the packets are substantially the same is checked in accordance with the difference between the highest probability of the PDF and the second-highest probability of the PDF. If the answer is no, it means the packets are not real-time video data. If the answer is yes, the packets stored in the entry are determined to be real-time video data. In step S208, a next entry to be identified in the data flow table is set. The above-mentioned packets are transmission control protocol (TCP) packets or user datagram protocol (UDP) packets.

In addition to the above-mentioned method, an apparatus for identifying packets in accordance with another embodiment is described as follows to enable those skilled in the art to practice the present invention.

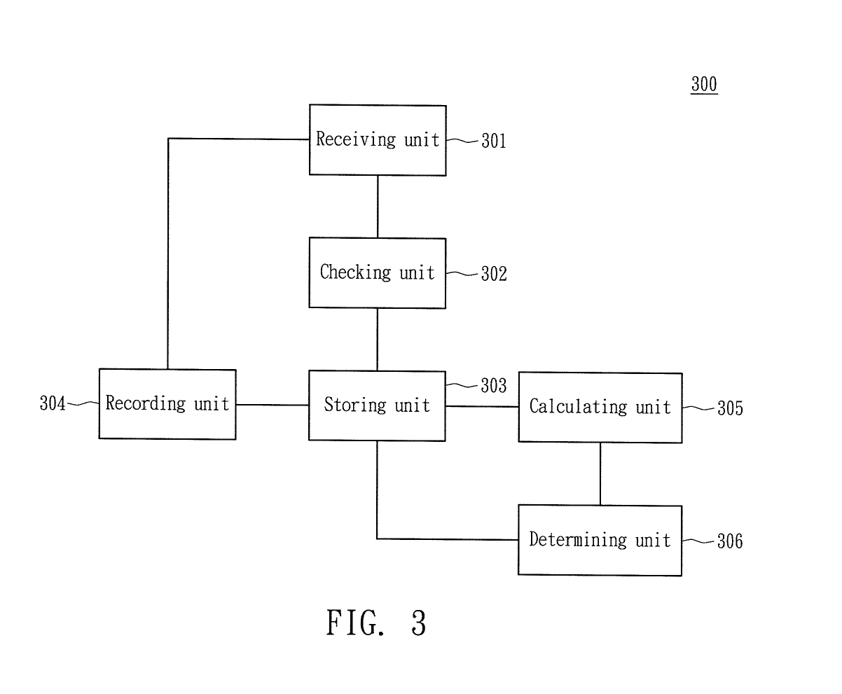

FIG. 3 is a block diagram of the apparatus for identifying packets in accordance with another exemplary embodiment of the present invention. The apparatus 300 for identifying packets comprises a receiving unit 301, a checking unit 302, a storing unit 303, a recording unit 304, a calculating unit 305 and a determining unit 306. The receiving unit 301 is utilized for receiving at least one packet. The checking unit 302 is utilized to check tuples of the packet and determine whether the packet is an identified datum and a monitored datum in accordance with a data flow table. If the packet is not the monitored datum, a new entry is created in the data flow table and the packet is stored in the new entry. The tuples comprise a source IP, a destination IP, a source port, a destination port and a protocol. The storing unit 303 is utilized to store the packet in the entry to which the packet belongs in accordance with the tuples of the packet. The recording unit 304 is utilized to record the arrival time and the length of the packet. In accordance with the packets stored in an entry of the data flow table, the calculation unit 305 is utilized to obtain a CDF, a PDF, a time interval under the condition of the CDF being a specified value, and a ratio of the quantity of the packets included within a specified range around the time interval. The PDF is a PDF of attributes of the packets. In accordance with an embodiment of the present invention, the attributes are length attributes. The specified value is about 0.5. The determining unit 306 is utilized to determine whether the attributes of the packets are substantially the same in accordance with the PDF and to identify the packets in accordance with the ratio and whether the attributes of the packets are substantially the same. The determining unit 306 is utilized to determine whether the attributes of the packets are substantially the same in accordance with the difference between the highest probability of the PDF and the second-highest probability of the PDF. The above-mentioned packets are TCP packets or UDP packets.

In summary, the method and apparatus of the present invention for identifying packets determine whether packets stored in each entry of a data flow table are real-time video packets and improve identification accuracy in accordance with the CDF of the arrival time intervals of the packets and the probability distribution function PDF of the lengths of the packets.

The above-described embodiments of the present invention are intended to be illustrative only. Numerous alternative embodiments may be devised by persons skilled in the art without departing from the scope of the following claims.

What is claimed is:

1. A method for identifying packets, comprising:
obtaining a cumulative distribution function (CDF) and a probability distribution function (PDF) in accordance with a plurality of packets stored in an entry of a data flow table;
obtaining a time interval under a condition of the CDF being a specified value;
obtaining a ratio of the quantity of the plurality of packets included within a given range of the time interval;
determining whether attributes of the plurality of packets are substantially the same in accordance with the PDF; and
identifying the plurality of packets in accordance with the ratio and the determining result.

2. The method of claim 1, further comprising steps of:
receiving at least one packet;
checking tuples of the packet;
determining whether the packet is an identified datum and a monitored datum in accordance with the data flow table;
storing the packet in the entry to which the packet belongs in accordance with the tuples of the packet;
creating a new entry in the data flow table and storing the packet in the new entry if the packet is not the monitored datum; and
recording an arrival time and the length of the packet.

3. The method of claim 1, further comprising the step of identifying the plurality of packets as real-time video data if the ratio is less than a threshold value and the attributes are substantially the same.

4. The method of claim 1, wherein the tuples comprise a source Internet Protocol (IP), a destination IP, a source port, a destination port and a protocol.

5. The method of claim 1, wherein the CDF represents arrival time intervals of the plurality of packets.

6. The method of claim 1, wherein the PDF represents the attributes of the plurality of packets.

7. The method of claim 6, wherein the attributes are length attributes.

8. The method of claim 1, wherein a difference between the highest probability and the second-highest probability of the PDF is utilized to determine whether the lengths of the packets are substantially the same.

9. The method of claim 1, wherein the specified value is about 0.5.

10. The method of claim 1, wherein the plurality of packets are transmission control protocol (TCP) packets or user datagram protocol (UDP) packets.

11. A wireless apparatus, comprising:
a calculation unit configured to obtain a cumulative distribution function (CDF), a probability distribution function (PDF), a time interval under a condition of the CDF being a specified value and a ratio of the quantity of the packets included within a given range of the time interval in accordance with a plurality packets stored in an entry of a data flow table; and
a determining unit configured to determine whether attributes of the plurality of packets are substantially the same in accordance with the PDF and to identify the plurality of packets in accordance with the ratio and the determining result.

12. The wireless apparatus of claim 11, further comprising:
a receiving unit configured to receive at least one packet;
a checking unit configured to check tuples of the packet and determine whether the packet is an identified datum and a monitored datum in accordance with a data flow table; if the packet is not the monitored datum, the checking unit creates a new entry in the data flow table and stores the packet in the new entry;
a storing unit configured to store the packet in the entry to which the packet belongs in accordance with the tuples of the packet; and
a recording unit configured to record the arrival time and the length of the packet.

13. The wireless apparatus of claim 12, wherein the tuples comprise a source IP, a destination IP, a source port, a destination port and a protocol.

14. The wireless apparatus of claim 11, wherein the CDF represents arrival time intervals of the plurality of packets.

15. The wireless apparatus of claim 11, wherein the PDF represents the attributes of the plurality of packets.

16. The wireless apparatus of claim 15, wherein the attributes are length attributes.

17. The wireless apparatus of claim 11, wherein a difference between the highest probability and the second-highest probability of the PDF is utilized to determine whether the lengths of the packets are substantially the same.

18. The wireless apparatus of claim 11, wherein the specified value is about 0.5.

19. The wireless apparatus of claim 11, wherein the plurality of packets are transmission control protocol (TCP) packets or user datagram protocol (UDP) packets.
